(19) United States
(12) Patent Application Publication
(10) Pub. No.: US 2002/0158817 A1
(43) Pub. Date: Oct. 31, 2002

(54) Display apparatus and information processing apparatus

(75) Inventor: Atsushi Matsuo, Tachikawa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/109,678

(22) Filed: Apr. 1, 2002

(30) Foreign Application Priority Data
Apr. 6, 2001 (JP) 2001-107936 (P)
Mar. 27, 2002 (JP) 2002-89830 (P)

(51) Int. Cl. G09G 3/04

(52) U.S. Cl. 345/33

(57) ABSTRACT

[OBJECT ] To provide a display apparatus by equipping the same with a storage device that performs mirroring of data for displaying or non-displaying with segments of a display device, and further has a storage region for storing other data, to thereby facilitate the control and reduce current consumption.

[MEANS FOR SOLUTION ] A display apparatus 1 of the present invention is equipped with a display device 2, pads 110-240, a RAM 250 and a CPU 260. By equipping the display apparatus 1 with the RAM 250 that has a storage region for mirroring data for displaying or non-displaying with segments in the display device 2, and further has a storage region for storing other data, the control is facilitated and current consumption is reduced when the CPU 260 requires a storage region.

### TECHNICAL FIELD

The present invention relates to display apparatuses. More particularly, the present invention relates to display apparatuses that display numbers, characters or marks with segments.

### BACKGROUND TECHNOLOGY

Conventionally, display apparatuses that display numbers, characters or marks with segments have been used. FIG. 2 schematically shows a structure of a conventional display apparatus. The conventional display apparatus will be described below with reference to FIG. 2.

Referring to FIG. 2, a conventional display apparatus 270 is equipped with a display device 280, and a main body 290. The main body 290 is equipped with pads 410-540, a RAM (Random Access Memory) 570, and a CPU (Central Processing Unit) 580.

The display device 280 is equipped with display regions 310-370 that display numbers or the like with seven segments. Each of the display regions 310-370 is a region that displays one number of the like with seven segments.

The display region 310 is equipped with display regions 311-312. The display region 311 is equipped with upper four segments 313-316 among seven segments that display one number of the like, and the display region 312 is equipped with lower three segments 317-319 among the seven segments that display one number of the like.

The display region 320 is equipped with display regions 321-322. The display region 321 is equipped with upper four segments 323-326 among seven segments that display one number of the like, and the display region 322 is equipped with lower three segments 327-329 among the seven segments that display one number of the like.

The display region 330 is equipped with display regions 331-332. The display region 331 is equipped with upper four segments 333-336 among seven segments that display one number of the like, and the display region 332 is equipped with lower three segments 337-339 among the seven segments that display one number of the like.

The display region 340 is equipped with display regions 341-342. The display region 341 is equipped with upper four segments 343-346 among seven segments that display one number of the like, and the display region 342 is equipped with lower three segments 347-349 among the seven segments that display one number of the like.

The display region 350 is equipped with display regions 351-352. The display region 351 is equipped with upper four segments 353-356 among seven segments that display one number of the like, and the display region 352 is equipped with lower three segments 357-359 among the seven segments that display one number of the like.

The display region 360 is equipped with display regions 361-362. The display region 361 is equipped with upper four segments 363-366 among seven segments that display one number of the like, and the display region 362 is equipped with lower three segments 367-369 among the seven segments that display one number of the like.

The display region 370 is equipped with display regions 371-372. The display region 371 is equipped with upper four segments 373-376 among seven segments that display one number of the like, and the display region 372 is equipped with lower three segments 377-379 among the seven segments that display one number of the like.

The pad 410 is equipped with storage sections 412-415, each of which stores 1-bit data, and a selector 411. The storage sections 412-415 correspond to the segments 313-316 in the display region 311, respectively, and store data indicative of display or non-display of the segments 313-316, respectively. The selector 411 reads data retained in the storage sections 412-415 at a predetermined cycle, and makes the segments 313-315 in the display region 311 display or non-display at a predetermined cycle according to the data.

The pad 420 is equipped with storage sections 422-424, each of which stores 1-bit data, and a selector 421. The storage sections 422-424 correspond to the segments 317-319 in the display region 312, respectively, and store data indicative of display or non-display of the segments 317-319, respectively. The selector 421 reads data retained in the storage sections 422-424 at a predetermined cycle, and makes the segments 317-319 in the display region 312 display or non-display at a predetermined cycle according to the data.

The pad 430 is equipped with storage sections 432-435, each of which stores 1-bit data, and a selector 431. The storage sections 432-435 correspond to the segments 323-326 in the display region 321, respectively, and store data indicative of display or non-display of the segments 323-326, respectively. The selector 431 reads data retained in the storage sections 432-435 at a predetermined cycle, and makes the segments 323-326 in the display region 321 display or non-display at a predetermined cycle according to the data.

The pad 440 is equipped with storage sections 442-444, each of which stores 1-bit data, and a selector 441. The storage sections 442-444 correspond to the segments 327-329 in the display region 322, respectively, and store data indicative of display or non-display of the segments 327-329, respectively. The selector 441 reads data retained in the storage sections 442-444 at a predetermined cycle, and makes the segments 327-329 in the display region 322 display or non-display at a predetermined cycle according to the data.

The pad 450 is equipped with storage sections 452-455, each of which stores 1-bit data, and a selector 451. The storage sections 452-455 correspond to the segments 333-336 in the display region 331, respectively, and store data indicative of display or non-display of the segments 333-336, respectively. The selector 451 reads data retained in the storage sections 452-455 at a predetermined cycle, and makes the segments 333-336 in the display region 331 display or non-display at a predetermined cycle according to the data.

The pad 460 is equipped with storage sections 462-464, each of which stores 1-bit data, and a selector 461. The storage sections 462-464 correspond to the segments 337-339 in the display region 332, respectively, and store data indicative of display or non-display of the segments 337-339, respectively. The selector 461 reads data retained in the storage sections 462-464 at a predetermined cycle, and makes the segments 337-339 in the display region 332 display or non-display at a predetermined cycle according to the data.

The pad 470 is equipped with storage sections 472-475, each of which stores 1-bit data, and a selector 471. The storage sections 472-475 correspond to the segments 343-346 in the display region 341, respectively, and store data indicative of display or non-display of the segments 343-346, respectively. The selector 471 reads data retained in the storage sections 472-475 at a predetermined cycle, and makes the segments 343-346 in the display region 341 display or non-display at a predetermined cycle according to the data.

The pad 480 is equipped with storage sections 482-484, each of which stores 1-bit data, and a selector 481. The storage sections 482-484 correspond to the segments 347-349 in the display region 342, respectively, and store data indicative of display or non-display of the segments 347-349, respectively. The selector 481 reads data retained in the storage sections 482-484 at a predetermined cycle, and makes the segments 347-349 in the display region 342 display or non-display at a predetermined cycle according to the data.

The pad 490 is equipped with storage sections 492-495, each of which stores 1-bit data, and a selector 491. The storage sections 492-495 correspond to the segments 353-356 in the display region 351, respectively, and store data indicative of display or non-display of the segments 353-356, respectively. The selector 491 reads data retained in the storage sections 492-495 at a predetermined cycle, and makes the segments 353-356 in the display region 351 display or non-display at a predetermined cycle according to the data.

The pad 500 is equipped with storage sections 502-504, each of which stores 1-bit data, and a selector 501. The storage sections 502-504 correspond to the segments 357-359 in the display region 352, respectively, and store data indicative of display or non-display of the segments 357-359, respectively. The selector 501 reads data retained in the storage sections 502-504 at a predetermined cycle, and makes the segments 357-359 in the display region 352 display or non-display at a predetermined cycle according to the data.

The pad 510 is equipped with storage sections 512-515, each of which stores 1-bit data, and a selector 511. The storage sections 512-515 correspond to the segments 363-366 in the display region 361, respectively, and store data indicative of display or non-display of the segments 363-366, respectively. The selector 511 reads data retained in the storage sections 512-515 at a predetermined cycle, and makes the segments 363-366 in the display region 361 display or non-display at a predetermined cycle according to the data.

The pad 520 is equipped with storage sections 522-524, each of which stores 1-bit data, and a selector 521. The storage sections 522-524 correspond to the segments 367-369 in the display region 362, respectively, and store data indicative of display or non-display of the segments 367-369, respectively. The selector 521 reads data retained in the storage sections 522-524 at a predetermined cycle, and makes the segments 367-369 in the display region 362 display or non-display at a predetermined cycle according to the data.

The pad 530 is equipped with storage sections 532-535, each of which stores 1-bit data, and a selector 531. The storage sections 532-535 correspond to the segments 373-376 in the display region 371, respectively, and store data indicative of display or non-display of the segments 373-376, respectively. The selector 531 reads data retained in the storage sections 532-535 at a predetermined cycle, and makes the segments 373-376 in the display region 371 display or non-display at a predetermined cycle according to the data.

The pad 540 is equipped with storage sections 542-544, each of which stores 1-bit data, and a selector 541. The storage sections 542-544 correspond to the segments 377-379 in the display region 372, respectively, and store data indicative of display or non-display of the segments 377-379, respectively. The selector 541 reads data retained in the storage sections 542-544 at a predetermined cycle, and makes the segments 377-379 in the display region 372 display or non-display at a predetermined cycle according to the data.

The storage sections 412-415, 422-424, 432-435, 442-444, 452-455, 462-464, 472-475, 482-484, 492-495, 502-504, 521-515, 522-524, 532-535, and 542-544, the RAM 570, the CPU 580 are mutually connected by a bus B2.

Data width of the CPU 580 is 4 bits for one address.

The storage sections 412-415 are mapped at bit 0-3 of an address 0000H in an address space of the CPU 580, and are only write accessible from the CPU 580.

The storage sections 422-424 are mapped at bit 0-2 of an address 0001H in the address space of the CPU 580, and are only write accessible from the CPU 580.

The storage sections 432-435 are mapped at bit 0-3 of an address 0002H in the address space of the CPU 580, and are only write accessible from the CPU 580.

The storage sections 442-444 are mapped at bit 0-2 of an address 0003H in the address space of the CPU 580, and are only write accessible from the CPU 580.

The storage sections 452-455 are mapped at bit 0-3 of an address 0004H in the address space of the CPU 580, and are only write accessible from the CPU 580.

The storage sections 462-464 are mapped at bit 0-2 of an address 0005H in the address space of the CPU 580, and are only write accessible from the CPU 580.

The storage sections 472-475 are mapped at bit 0-3 of an address 0006H in the address space of the CPU 580, and are only write accessible from the CPU 580.

The storage sections 482-484 are mapped at bit 0-2 of an address 0007H in the address space of the CPU 580, and are only write accessible from the CPU 580.

The storage sections 492-495 are mapped at bit 0-3 of an address 0008H in the address space of the CPU 580, and are only write accessible from the CPU 580.

The storage sections 502-504 are mapped at bit 0-2 of an address 0009H in the address space of the CPU 580, and are only write accessible from the CPU 580.

The storage sections 512-515 are mapped at bit 0-3 of an address 000AH in the address space of the CPU 580, and are only write accessible from the CPU 580.

The storage sections 522-524 are mapped at bit 0-2 of an address 000BH in the address space of the CPU 580, and are only write accessible from the CPU 580.

The storage sections 532-535 are mapped at bit 0-3 of an address 000CH in the address space of the CPU 580, and are only write accessible from the CPU 580.

The storage sections 542-544 are mapped at bit 0-2 of an address 000DH in the address space of the CPU 580, and are only write accessible from the CPU 580.

The RAM 570 has a data storage region of 4 bits for one address. The total of the storage regions is 56 bits. The RAM 570 is a mirror RAM for the storage sections 412-415, 422-424, 432-435, 442-444, 452-455, 462-464, 472-475, 482-484, 492-495, 502-504, 521-515, 522-524, 532-535, and 542-544, which are mapped at addresses 0000H-000DH in the address space of the CPU 580. The RAM 570 is both read accessible and write accessible from the CPU 580.

In the conventional display apparatus 270, the CPU 580 writes data in the storage sections 412-415, 422-424, 432-435, 442-444, 452-455, 462-464, 472-475, 482-484, 492-495, 502-504, 521-515, 522-524, 532-535, and 542-544, according to numbers or the like desired to be displayed, such that the desired numbers or the like can be displayed with seven segments in the display regions 310-370 of the display device 280.

In the conventional display apparatus 270, a total of 7 bits, bit 3 of the address 0001H, bit 3 of the address 0003H, bit 3 of the address 0005H, bit 3 of the address 0007H, bit 3 of the address 0009H, bit 3 of the address 000BH and bit 3 of the address 000DH, within the RAM 570 are not used. Therefore, when the CPU 580 needs storage regions for some reasons, it is ideal if these unused 7 bits in the RAM 570 can be effectively used.

However, directly operating the 7 unused bits in the RAM 570 independently from one another leads to a problem that a program for having the CPU 580 operate these bits becomes complicated. Also, this leads to other problems. Because the program becomes complicated, the processing time by the CPU 580 becomes longer, and the current consumption increases.

Also, it may be possible that, by reducing the addresses at which the storage sections 412-415, 422-424, 432-435, 442-444, 452-455, 462-464, 472-475, 482-484, 492-495, 502-504, 521-515, 522-524, 532-535, and 542-544 in the address space of the CPU 580 are mapped, the unused bits within the RAM 570 can be mapped at bit 1-bit 3 of the address 000CH and bit 0-bit 3 of the address 000DH. However, if the mapping were changed in this manner, each of the addresses of the respective storage sections 412-415, 422-424, 432-435, 442-444, 452-455, 462-464, 472-475, 482-484, 492-495, 502-504, 521-515, 522-524, 532-535, and 542-544 would cross the 4-bit boundary. This causes a problem in which the program that is processed by the CPU 580 to display numbers or the like on the display device 280 becomes complicated. Because the program becomes complicated, the processing time by the CPU 580 becomes longer, and the current consumption increases.

Also, another possibility is that the unused bits within the RAM 570 may be mapped at bit 0-bit 3 of the address 000EH and bit 0-bit 2 of the address 000FH within the address space of the CPU 580. However, since the RAM 57 has only addresses 0000H-000DH, the unused bits in the RAM 570 cannot mapped at bit 0-bit 3 of the address 000EH and bit 0-bit 2 of the address 000FH within the address space of the CPU 580.

The present invention is made in view of the problems described above, and its object is to provide a display apparatus equipped with a storage device that performs mirroring of data for displaying or non-displaying segments of a display device, and having a storage region for storing other data to thereby facilitate the control and reduce current consumption when a storage region is required.

### DESCRIPTION OF THE INVENTION

To solve the problems described above, a display apparatus in accordance with the present invention is characterized in comprising a display device that displays numbers, characters or marks with segments, a segment data storage device that stores data for displaying or non-displaying each of the segments of the display device, a display control device that has the display device display numbers, characters or marks with the segments according to the data stored in the segment data storage device, and a storage device that performs mirroring of the data stored in the segment data storage device, and has anther storage region for storing other data.

Here, the display device can display one number, character or mark with 7 segments. Also, the storage device can store 4-bit data or 8-bit data for one address.

By providing a storage device that performs mirroring of data for displaying or non-displaying each segment, and has a storage region for storing other data, the control is facilitated and current consumption is reduced when a storage region is required.

A data processing apparatus in accordance with the present invention is characterized in comprising:

a segment data storage device that stores data for displaying or non-displaying segments of the display device;

a display control device that outputs the data stored in the segment data storage device to the segments based on signals; and

a storage device that performs mirroring of the data stored in the segment data storage device,

wherein data allocated at one address is outputted to segments at different display regions.

### BRIEF DESCRIPTION OF THE DRAWINGS

FIG. 1 schematically shows a display apparatus in accordance with a first embodiment of the present invention.

FIG. 2 schematically shows an implementation of a conventional display apparatus.

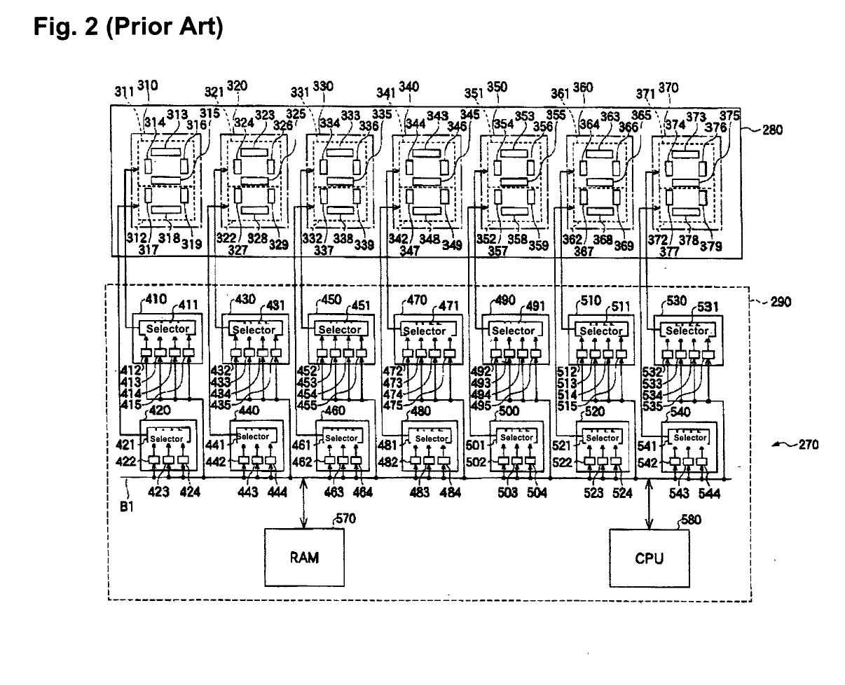

FIG. 3 schematically shows a display apparatus in accordance with a second embodiment of the present invention.

### DESCRIPTION OF REFERENCE NUMBERS

1, 800 Display apparatus

2, 600 Display device

3, 700 Main body

10, 20, 30, 40, 50, 60, 70, 610, 620, 630, 640, 650, 660, 670, and 680

Display regions (part of them omitted from the drawings)

13-19, 23-29, 33-39, 43-49, 53-59, 63-69, 73-79, 613-619, 623-629, 633-639, 643-649, 653-659, 663-669, 673-679, 683-689

Display segments (part of them omitted from the drawings)

110, 120, 130, 140, 150, 160, 170, 180, 190, 200, 210, 220, 230, 240

Pads

112-115, 122-124, 132-135, 142-144, 152-155, 162-164, 172-175, 182-184, 192-195, 202-204, 212-215, 222-224, 232-235, 242-244, 713-720, 723-730, 733-740, 743-750, 753-760, 763-770, 773-780

Storage sections (part of them omitted from the drawings)

111, 121, 131, 141, 151, 161, 171, 181, 191, 201, 211, 221, 231, 241

Selectors

S1-S7 Selection signals

T11-T18, T21-T28, T31-T38, T41-T48, T51-T58, T61-T68, T71-T78

Transistors (part of them omitted from the drawings)

250, 850 RAM

260, 860 CPU

### EMBODIMENTS OF THE PRESENT INVENTION

A display apparatus in accordance with the present invention will be described in detail below with reference to the accompanying drawings.

(First Embodiment)

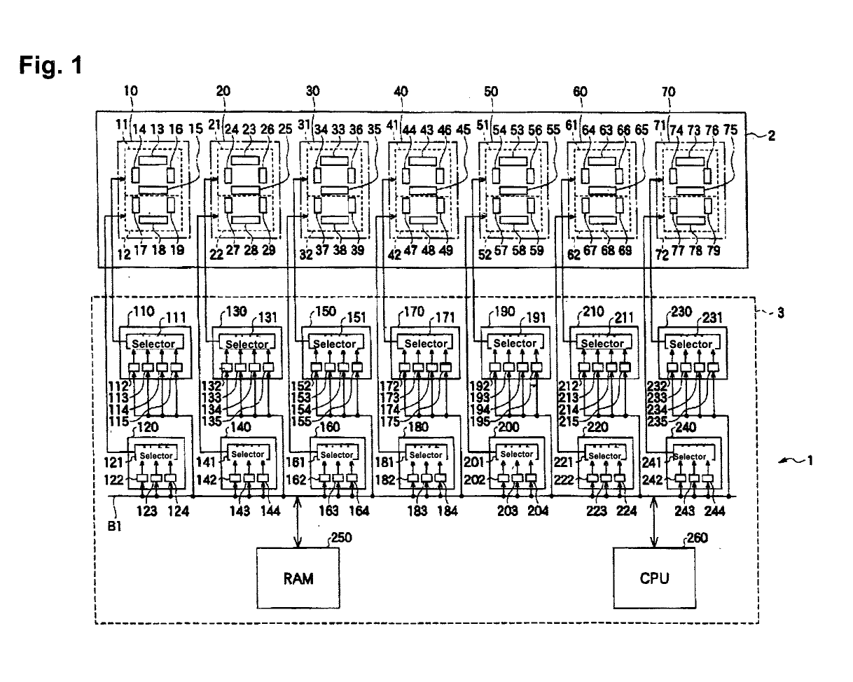

FIG. 1 schematically shows a display apparatus in accordance with a first embodiment of the present invention.

Referring to FIG. 1, the display apparatus 1 is equipped with a display device 2, and a main body 3. The main body 3 is equipped with pads 110-240, a RAM 250, and a CPU 260.

The display device 2 is equipped with display regions 10-70 that display numbers or the like with seven segments. Each of the display regions 10-70 is a region that displays one number of the like with seven segments.

The display region 10 is equipped with display regions 11-12. The display region 11 is equipped with upper four segments 13-16 among seven segments that display one number of the like, and the display region 12 is equipped with lower three segments 17-19 among the seven segments that display one number of the like.

The display region 20 is equipped with display regions 21-22. The display region 21 is equipped with upper four segments 23-26 among seven segments that display one number of the like, and the display region 22 is equipped with lower three segments 27-29 among the seven segments that display one number of the like.

The display region 30 is equipped with display regions 31-32. The display region 31 is equipped with upper four segments 33-36 among seven segments that display one number of the like, and the display region 32 is equipped with lower three segments 37-39 among the seven segments that display one number of the like.

The display region 40 is equipped with display regions 41-42. The display region 41 is equipped with upper four segments 43-46 among seven segments that display one number of the like, and the display region 42 is equipped with lower three segments 47-49 among the seven segments that display one number of the like.

The display region 50 is equipped with display regions 51-52. The display region 51 is equipped with upper four segments 53-56 among seven segments that display one number of the like, and the display region 52 is equipped with lower three segments 57-59 among the seven segments that display one number of the like.

The display region 60 is equipped with display regions 61-62. The display region 61 is equipped with upper four segments 63-66 among seven segments that display one number of the like, and the display region 62 is equipped with lower three segments 67-69 among the seven segments that display one number of the like.

The display region 70 is equipped with display regions 71-72. The display region 71 is equipped with upper four segments 73-76 among seven segments that display one number of the like, and the display region 72 is equipped with lower three segments 77-79 among the seven segments that display one number of the like.

The pad 110 is equipped with storage sections 112-115, each of which stores 1-bit data, and a selector 111. The storage sections 112-115 correspond to the segments 13-16 in the display region 11, respectively, and store data indicative of display or non-display of the segments 13-16, respectively. The selector 111 reads data retained in the storage sections 112-115 at a predetermined cycle, and makes the segments 13-15 in the display region 11 display or non-display at a predetermined cycle according to the data.

The pad 120 is equipped with storage sections 122-124, each of which stores 1-bit data, and a selector 121. The storage sections 122-124 correspond to the segments 17-19 in the display region 12, respectively, and store data indicative of display or non-display of the segments 17-19, respectively. The selector 121 reads data retained in the storage sections 122-124 at a predetermined cycle, and makes the segments 17-19 in the display region 12 display or non-display at a predetermined cycle according to the data.

The pad 130 is equipped with storage sections 132-135, each of which stores 1-bit data, and a selector 131. The storage sections 132-135 correspond to the segments 23-26 in the display region 21, respectively, and store data indicative of display or non-display of the segments 23-26, respectively. The selector 131 reads data retained in the storage sections 132-135 at a predetermined cycle, and makes the segments 23-26 in the display region 21 display or non-display at a predetermined cycle according to the data.

The pad 140 is equipped with storage sections 142-144, each of which stores 1-bit data, and a selector 141. The storage sections 142-144 correspond to the segments 27-29 in the display region 22, respectively, and store data indicative of display or non-display of the segments 27-29, respectively. The selector 141 reads data retained in the storage sections 142-144 at a predetermined cycle, and makes the segments 27-29 in the display region 22 display or non-display at a predetermined cycle according to the data.

The pad 150 is equipped with storage sections 152-155, each of which stores 1-bit data, and a selector 151. The storage sections 152-155 correspond to the segments 33-36 in the display region 31, respectively, and store data indicative of display or non-display of the segments 33-36, respectively. The selector 151 reads data retained in the storage sections 152-155 at a predetermined cycle, and makes the segments 33-36 in the display region 31 display or non-display at a predetermined cycle according to the data.

The pad 160 is equipped with storage sections 162-164, each of which stores 1-bit data, and a selector 161. The storage sections 162-164 correspond to the segments 37-39 in the display region 32, respectively, and store data indicative of display or non-display of the segments 37-39, respectively. The selector 461 reads data retained in the storage sections 162-164 at a predetermined cycle, and makes the segments 37-39 in the display region 32 display or non-display at a predetermined cycle according to the data.

The pad 170 is equipped with storage sections 172-175, each of which stores 1-bit data, and a selector 171. The storage sections 172-175 correspond to the segments 43-46 in the display region 41, respectively, and store data indicative of display or non-display of the segments 43-46, respectively. The selector 171 reads data retained in the storage sections 172-175 at a predetermined cycle, and makes the segments 43-46 in the display region 41 display or non-display at a predetermined cycle according to the data.

The pad 180 is equipped with storage sections 182-184, each of which stores 1-bit data, and a selector 181. The storage sections 182-184 correspond to the segments 47-49 in the display region 42, respectively, and store data indicative of display or non-display of the segments 47-49, respectively. The selector 181 reads data retained in the storage sections 182-184 at a predetermined cycle, and makes the segments 47-49 in the display region 42 display or non-display at a predetermined cycle according to the data.

The pad 190 is equipped with storage sections 192-195, each of which stores 1-bit data, and a selector 191. The storage sections 192-195 correspond to the segments 53-56 in the display region 51, respectively, and store data indicative of display or non-display of the segments 53-56, respectively. The selector 191 reads data retained in the storage sections 192-195 at a predetermined cycle, and makes the segments 53-56 in the display region 51 display or non-display at a predetermined cycle according to the data.

The pad 200 is equipped with storage sections 202-204, each of which stores 1-bit data, and a selector 201. The storage sections 202-204 correspond to the segments 57-59 in the display region 52, respectively, and store data indicative of display or non-display of the segments 57-59, respectively. The selector 201 reads data retained in the storage sections 202-204 at a predetermined cycle, and makes the segments 57-59 in the display region 52 display or non-display at a predetermined cycle according to the data.

The pad 210 is equipped with storage sections 212-215, each of which stores 1-bit data, and a selector 211. The storage sections 212-215 correspond to the segments 63-66 in the display region 61, respectively, and store data indicative of display or non-display of the segments 63-66, respectively. The selector 211 reads data retained in the storage sections 212-215 at a predetermined cycle, and makes the segments 63-66 in the display region 61 display or non-display at a predetermined cycle according to the data.

The pad 220 is equipped with storage sections 222-224, each of which stores 1-bit data, and a selector 221. The storage sections 222-224 correspond to the segments 67-69 in the display region 62, respectively, and store data indicative of display or non-display of the segments 67-69, respectively. The selector 221 reads data retained in the storage sections 222-224 at a predetermined cycle, and makes the segments 67-69 in the display region 62 display or non-display at a predetermined cycle according to the data.

The pad 230 is equipped with storage sections 232-235, each of which stores 1-bit data, and a selector 231. The storage sections 232-235 correspond to the segments 73-76 in the display region 71, respectively, and store data indicative of display or non-display of the segments 73-76, respectively. The selector 231 reads data retained in the storage sections 232-235 at a predetermined cycle, and makes the segments 73-76 in the display region 71 display or non-display at a predetermined cycle according to the data.

The pad 240 is equipped with storage sections 242-244, each of which stores 1-bit data, and a selector 241. The storage sections 242-244 correspond to the segments 77-79 in the display region 72, respectively, and store data indicative of display or non-display of the segments 77-79, respectively. The selector 241 reads data retained in the storage sections 242-244 at a predetermined cycle, and makes the segments 77-79 in the display region 72 display or non-display at a predetermined cycle according to the data.

The storage sections 112-115, 122-124, 132-135, 142-144, 152-155, 162-164, 172-175, 182-184, 192-195, 202-204, 221-215, 222-224, 232-235, and 242-244, the RAM 270, the CPU 260 are mutually connected by a bus B1.

Data width of the CPU 260 is 4 bits for one address.

The storage sections 112-115 are mapped at bit 0-3 of an address 0000H in an address space of the CPU 260, and are only write accessible from the CPU 260.

The storage sections 122-124 are mapped at bit 0-2 of an address 0001H in the address space of the CPU 260, and are only write accessible from the CPU 260.

The storage sections 132-135 are mapped at bit 0-3 of an address 0002H in the address space of the CPU 260, and are only write accessible from the CPU 260.

The storage sections 142-144 are mapped at bit 0-2 of an address 0003H in the address space of the CPU 260, and are only write accessible from the CPU 260.

The storage sections 152-155 are mapped at bit 0-3 of an address 0004H in the address space of the CPU 260, and are only write accessible from the CPU 260.

The storage sections 162-164 are mapped at bit 0-2 of an address 0005H in the address space of the CPU 260, and are only write accessible from the CPU 260.

The storage sections 172-175 are mapped at bit 0-3 of an address 0006H in the address space of the CPU 260, and are only write accessible from the CPU 260.

The storage sections 182-184 are mapped at bit 0-2 of an address 0007H in the address space of the CPU 260, and are only write accessible from the CPU 260.

The storage sections 192-195 are mapped at bit 0-3 of an address 0008H in the address space of the CPU 260, and are only write accessible from the CPU 260.

The storage sections 202-204 are mapped at bit 0-2 of an address 0009H in the address space of the CPU 260, and are only write accessible from the CPU 260.

The storage sections 212-215 are mapped at bit 0-3 of an address 000AH in the address space of the CPU 260, and are only write accessible from the CPU 260.

The storage sections 222-224 are mapped at bit 0-2 of an address 000BH in the address space of the CPU 260, and are only write accessible from the CPU 260.

The storage sections 232-235 are mapped at bit 0-3 of an address 000CH in the address space of the CPU 260, and are only write accessible from the CPU 260.

The storage sections 242-244 are mapped at bit 0-2 of an address 000DH in the address space of the CPU 260, and are only write accessible from the CPU 260.

The RAM 250 has a data storage region of 4 bits for one address, and the total of the storage regions is 64 bits. The RAM 250 is mapped at addresses 0000H-000FH in the address space of the CPU 260, and is a mirror RAM (corresponding to addresses 000H-000DH) for the storage sections 112-115, 122-124, 132-135, 142-144, 152-155, 162-164, 172-175, 182-184, 192-195, 202-204, 221-215, 222-224, 232-235, and 242-244, and further includes a storage region for one byte (8 bits) (corresponding to addresses 000EH-000FH). The RAM 250 is both read accessible and write accessible from the CPU 260.

Next, a description will be made as to an operation of the display apparatus 1 when displaying characters or the like in the display region 10.

First, the CPU 260 writes data representative of a character or the like to be displayed in the storage sections 112-115 and 122-124. The data written by the CPU 260 in the storage sections 112-115 and 122-124 are also written in the RAM 250, a mirror RAM.

Next, the selector 111 reads the data stored in the storage regions 112-115 at a predetermined cycle, and has the segments 13-16 display or non-display according to the data. On the other hand, the selector 121 reads the data stored in the storage regions 122-124 at a predetermined cycle, and has the segments 17-19 display or non-display according to the data.

In this manner, a number or the like can be displayed in the display region 10. Similarly, characters or the like can be displayed in the display regions 20-70.

Also, the RAM 250 includes the storage region (corresponding to addresses 000EH-000FH) for one byte (8 bits) that is not used as a mirror RAM for the storage sections 112-115, 122-124, 132-135, 142-144, 152-155, 162-164, 172-175, 182-184, 192-195, 202-204, 221-215, 222-224, 232-235, and 242-244, and the CPU 260 can used this storage region.

In this manner, the display apparatus 1 in accordance with the present embodiment is equipped with the RAM 250 that has the storage region (corresponding to addresses 0000H-000DH) for mirroring the storage regions 112-115, 122-124, 132-135, 142-144, 152-155, 162-164, 172-175, 182-184, 192-195, 202-204, 221-215, 222-224, 232-235 and 242-244, which store data for displaying or non-displaying the respective segments 13-19, 23-29, 33-39, 43-49, 53-59, 63-69 and 73-79 within the display device 2, and also the storage region (corresponding to addresses 000EH-000FH) for storing other data. As a result, when the CPU 260 requires a storage region, its control is facilitated and current consumption can be reduced.

One embodiment example of a display apparatus in accordance with the present invention has been described above. The storage capacity of the RAM 250 may be further increased.

(Second Embodiment)

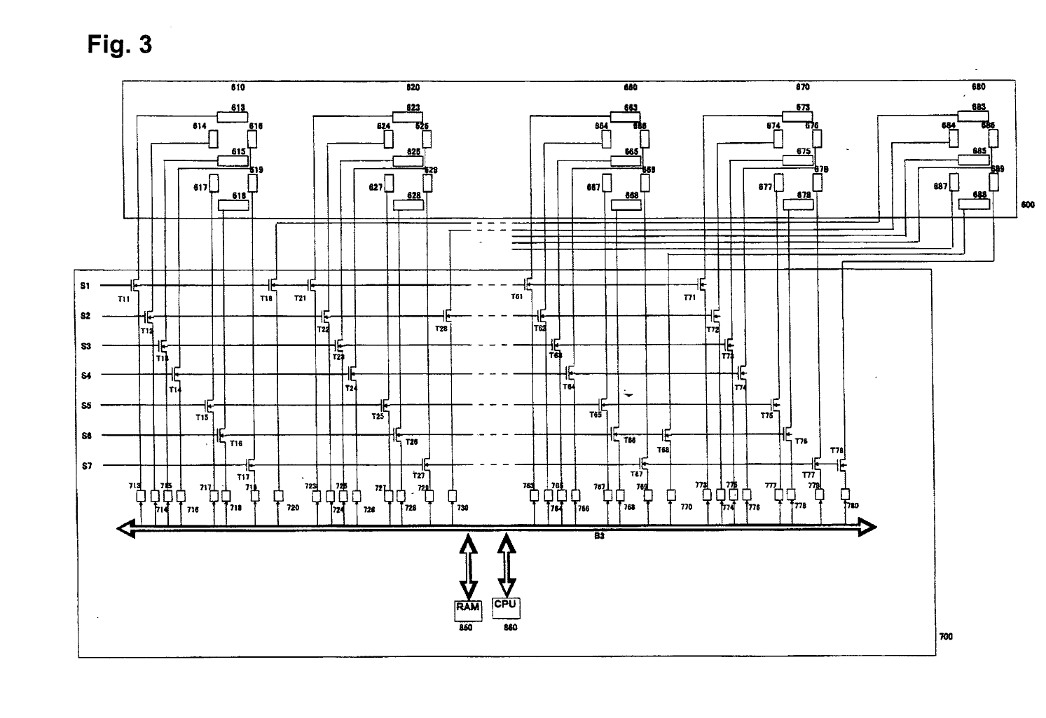

FIG. 3 schematically shows a structure of a display apparatus in accordance with a second embodiment of the present invention. Referring to FIG. 3, a display apparatus 800 is equipped with a display device 600 having eight display regions 610, 620, 630, 640, 650, 660, 670 and 680, and a main body 700. The main body 700 is equipped with the following components:

Transistors T11, T21, T31, T41, T51, T61, T71 and T18, which receive a selection signal S1 as a gate input, and have display segments 613, 623, 624, 625, 626, 626, 627 and 687, and storage sections 713, 723, 733, 743, 753, 763, 773 as their sources or drains.

Similarly, transistors that receive selection signals S2-S7, respectively.

Storage sections 713-719 that correspond to display segments 613-619. Similarly, (intermediate portions omitted), storage sections 773-779 that correspond to display segments 673-679, and storage sections 720, 730, 740, 750, 760, 770, and 780 that correspond to display segments 683-689.

RAM 850. CPU 860.

The select signals S1-S7 reflect data retained at the storage sections 713-720, 723-730, 733-740, 743-750, 753-760, 763-770 and 773-780 on the segments 613-619, 623-629, 633-639, 643-649, 653-659, 663-669, 673-679 and 683-689 in the display device 600 at a predetermined cycle. In other words, charges stored in the storage sections are moved to the display segments at a predetermined cycle, to thereby light the segments on and off.

The storage sections 713-720, 723-730, 733-740, 743-750, 753-760, 763-770 and 773-780, the RAM 850 and the CPU 860 are mutually connected by a bus B3.

Data width of the CPU 860 is 4 bits for one address.

The storage sections 713-716 are mapped bit 0-3 of an address 0000H in an address space of the CPU 860, and are only write accessible from the CPU 860.

The storage sections 717-720 are mapped bit 0-3 of an address 0001H in the address space of the CPU 860, and are only write accessible from the CPU 860.

The others are similarly mapped.

The storage sections 773-776 are mapped bit 0-3 of an address 000CH in the address space of the CPU 860, and are only write accessible from the CPU 860.

The storage sections 777-780 are mapped bit 0-3 of an address 000DH in the address space of the CPU 860, and are only write accessible from the CPU 860.

The RAM 850 has a data storage region of 4 bits for one address, and the total of the storage regions is 64 bits.

The RAM 850 is mapped at addresses 0000H-000FH in the address space of the CPU 860, and is a mirror RAM (corresponding to addresses 000H-000DH) for the storage sections 713-720, 723-730, 733-740, 743-750, 753-760, 763-770, 773-780, and further includes a storage region for one byte (8 bits) (corresponding to addresses 000EH-000FH). The RAM 850 is both read accessible and write accessible from the CPU 860.

Next, a description will be made as to an operation of the display apparatus 800 when displaying characters or the like in the display device 600.

First, the CPU 860 writes data corresponding to characters or the like to be displayed in the storage sections 713-720, 723-730, 733-740, 743-750, 753-760, 763-770, 773-780. The data written by the CPU 860 in the storage sections 713-720, 723-730, 733-740, 743-750, 753-760, 763-770, 773-780 are also written in the RAM 850, a mirror RAM.

Next, the select signals S1-S7 are inputted, and according to the data stored in the storage sections 713-720, 723-730, 733-740, 743-750, 753-760, 763-770, 773-780, the segments corresponding to the respective storage sections are displayed or non-displayed. Here, the storage sections 720, 730, 740, 750, 760, 770 and 780 correspond to the display segments 683, 684, 685, 686, 687, 688 and 689 within the display region 680, respectively.

Also, since the RAM 850 has a storage region for 64 bits, and addresses that are used for display are 0000H-000DH, a storage region (addresses 000EH-000FH) for one byte (8 bits) remains as an extra region, and the CPU 860 can used this region for purposes other than display.

Also, if stored data is read from the storage sections 713-720, 723-730, 733-740, 743-750, 753-760, 763-770, 773-780, current consumption may increase because charges required to display with the display segments are stored. However, in accordance with the present invention, display data that has been mirrored in the RAM 850 are read out, which achieves a lowered current consumption.

The display apparatuses in accordance with the embodiments of the present invention have been described so far, and the storage capacity of the RAM 850 can be further increased.

Also, the embodiments are not limited to an address width of 4 bits. For example, an address width of 8 bits would also enable mirroring display data on the RAM 850, and creating an extra storage region for 8 bits.

### POSSIBILITY OF INDUSTRIAL UTILITY

As described above, a display apparatus in accordance with the present invention is equipped with a storage device that performs mirroring of data for displaying or non-displaying each segment, and further has a storage region that stores other data. As a result, when a storage region is required, the control is facilitated, and current consumption is reduced. Also, data is effectively allocated across the address width, such that the RAM 850 can be effectively used.

Scope of claims:

1. A display apparatus is characterized in comprising:
a display device that displays numbers, characters or marks with segments;
a segment data storage device that stores data for displaying or non-displaying each of the segments of the display device;
a display control device that has the display device display numbers, characters or marks with the segments according to the data stored in the segment data storage device; and
a storage device that performs mirroring of the data stored in the segment data storage device, and has anther storage region for storing other data.

2. A display apparatus according to claim 1, wherein the display device displays one number, character or mark with 7 segments.

3. A display apparatus according to claim 1 or claim 2, wherein the storage device stores 4-bit data or 8-bit data for one address.

4. A data processing apparatus characterized in comprising:
a segment data storage device that stores data for displaying or non-displaying segments of a display device;
a circuit that outputs the data stored in the segment data storage device to the segments based on signals; and
a storage device that performs mirroring of the data stored in the segment data storage device,
wherein data allocated at one address is outputted to segments at different display regions.
